(19) United States
(12) Patent Application Publication
(10) Pub. No.: US 2014/0008187 A1
(43) Pub. Date: Jan. 9, 2014

(54) MODULAR CONVEYOR MAT AND MODULE THEREFOR

(71) Applicants: Leonardus Adrianus Catharinus Cornelissen, 's-Gravenhage (NL); Ronaki Sigmond, Schiedam (NL)

(72) Inventors: Leonardus Adrianus Catharinus Cornelissen, 's-Gravenhage (NL); Ronaki Sigmond, Schiedam (NL)

(21) Appl. No.: 13/990,268

(22) PCT Filed: Nov. 29, 2011
(86) PCT No.: PCT/NL11/50812

§ 371 Date: Sep. 25, 2013

(30) Foreign Application Priority Data
Nov. 30, 2010 (NL) 2005790

(51) Int. Cl. B65G 15/32

(52) U.S. Cl. CPC B65G 15/32
USPC 198/853

(57) ABSTRACT

A module (3) for a modular conveyor mat (1), comprising a body part (7) which extends between two molded sides (5) transversely to a conveying direction (P) along a main axis (4). The body part (7) is provided with one or more break provisions (16) extending in conveying direction (P) for breaking the module therealong. An end surface (13) of the body part (7) located at a molded side (5) is, transversely to the conveying direction (8), at a distance (A1) from a first reference plane (R1) which is at least locally smaller than the distance (A2) from a central plane (M) through the break provision (16) to a second reference plane (R2). Here, counted transversely to the conveying direction (P), the first reference plane (R1) extend from the mold-formed side (5) centrally between the first two pairs of coupling elements (11,12), and, counted from the central plane (M) transversely to the conveying direction, the second reference plane (R2) extends centrally between the first two pairs of coupling elements. The central plane (M) and the reference planes (R1, R2) are oriented transversely to the main axis (H).

The invention relates to a module for a modular conveyor mat, and to a conveyor mat built up from modules.

Such modules and mats are generally known and are used for conveying products. As a rule, the modules are manufactured by means of mold formation, and are often manufactured from plastic material.

A customary module comprises a body part extending between two molded sides, transversely to the conveying direction along a main axis, with a top side for carrying products to be conveyed and a lower side for cooperation with a conveying track. At the front and rear side viewed in conveying direction, the body part comprises coupling elements. Here, opposite coupling elements at the front and rear side form a pair. The coupling elements at both the front and the rear side comprise a series of successive hinge parts with adjacent receiving spaces alternating transversely to the conveying direction, so that hinge parts and receiving spaces can interdigitate with receiving spaces and hinge parts of similar modules successive in conveying direction. Successive modules can be hingedly coupled by means of hinge pins reaching transversely to the conveying direction through hinge bores provided in the hinge parts.

In this manner, modules successive in conveying direction can be joined to form a mat of a desired length. The mat is usually of endless design so that it can be led over a conveying track by means of return wheels. The width of the mat can be varied by placing several modules side by side transversely to the conveying direction and coupling them by means of continuous hinge pins. Rows of modules successive in conveying direction are often staggered relative to each other in conveying direction, so that continuous cracks between the modules of the mat in conveying direction can be prevented.

As they are molded, the modules mutually have only relatively small deviations regarding size, surface and shape. As a result, the modules can be well formed into a mat. Because of the relatively high costs of molds, the modules are usually manufactured in only a limited number of width sizes. When a mat of deviant width is required, the modules are often sawed to size. This has as a disadvantage that only one of the sawed parts of the modules can be used in the mat because due to the saw-cut, the other part has become too short to be included in the mat without causing a crack. In addition, the sawed modules must often be de-burred, so that customizing the modules is a relatively labour intensive and expensive process.

In U.S. Pat. No. 5,215,185 of applicant, it is proposed to provide the body part of the modules with at least one break provision extending in conveying direction, for breaking therealong the module over its width into break parts, at the location of a hinge part. As, when breaking, no material is lost in a saw-cut, in principle both module parts can be used. However, in practice, it has appeared that often, the break line deflects somewhat from the intended location, and that the break line is too rough so that often, one of the break parts is too wide to be used in the mat without finishing operations. In addition, the rough fractured surface can damage the products so that in practice, still relatively many finishing operations are required and sometimes it is even not suitable for use at all. Further, the division over a hinge part leads to a weakening of the hinge part.

The object of the invention is to provide a module for a modular conveyor mat and a conveyor mat built up from such modules with which, while maintaining the advantages mentioned, the disadvantages mentioned can be prevented. To that end, the invention provides a module for a modular conveyor mat, comprising a body part extending between two molded sides transversely to the conveying direction along a main axis, with a top side for carrying products to be conveyed and a lower side for cooperation with a conveying track, the body part being provided, at the front and rear side as viewed in conveying direction with coupling elements, with opposite coupling elements at the front and rear side forming a pair, and wherein the coupling elements comprise, at the front as well as the rear side, a series of alternating hinge parts and receiving spaces transversely to the conveying direction, so that hinge parts and receiving spaces can interdigitate with receiving spaces and hinge parts of similar modules successive in conveying direction, and the successive modules can be hingedly coupled by means of hinge pins, reaching through hinge bores provided in the hinge parts, and extending transversely to the conveying direction, the body part being provided with one or more break provisions extending in conveying direction for breaking the module therealong in width parts, while an end surface of the body part located at a molded side has a distance, transversely to the conveying direction, to a first reference plane that is at least locally smaller than the distance from a central plane through the break provision to a second reference plane, while the first reference plane extends, counted from the molded side transversely to the conveying direction, centrally between the first two pairs of coupling elements, and wherein the second reference plane extends, counted from the central plane transversely to the conveying direction, centrally between the first two pairs of coupling elements, and wherein the central plane and the reference planes are oriented transversely to the main axis. By thus designing an end surface located at a molded side to be fully or partly receding transversely to the conveying direction, in the conveyor mat to be formed with the modules a compensation space can be created. With such a compensation space, it can be achieved that when breaking the module, the line of fracture, at least locally, slightly deflects from the central plane, and due to the rough line of fracture at the broken off side, one of the break parts has a projection, which break part can still be included in the mat. The break part can then be placed with the broken side adjacent a molded side of another module, so that the space occupied by the projection can be compensated for with the compensation space created by means of the locally receded end surface. Then, both break parts of the modules can still be included in the conveyor mat without finishing operations. The end surface can be designed to be receding in its entirety, but can also be provided at one or more locations in the surface with a recess or notch, for instance a cavity in the centre of the end surface. The distance between the end surface and the first reference plane is for instance approximately 2% to approximately 20% smaller than the distance between the central plane and the second reference plane, preferably approximately 5% to approximately 15%. Depending on the dimensions and geometry of the module, the difference in distance can be, for instance, approximately 0.2-0.3 mm.

The break provision can be designed as a continuous or non-continuous break line or material weakening. Such a material weakening can for instance be configured as one or more breaking rods, whose position corresponds with the compensation spaces recessed in the end surface, or compensation spaces to be created by the end surface. By designing the break provision as a groove extending at the top, and preferably also at the front side and back side of the module, the module can be broken without tools in a reliable manner.

When the break provision in the body part is located at the location of the boundary between a hinge part and an adjacent receiving space, a well defined breaking area can be provided with a relatively short line of fracture. It is noted that this feature can also, in itself, be advantageously applied, for instance with a module according to the preamble of claim 1 without the characterizing features mentioned there, and can thus be considered to be an invention in itself.

When a top edge of the break provision is located at a distance from a conveying face formed by the top of the module, during use, a possibly rough side of the fractured surface can be below the conveying surface. It is noted that this feature can also, in itself, be advantageously applied, for instance with a module according to the preamble of claim 1, without the characterizing features mentioned there, and can thus be considered to be an invention in itself.

When the conveying surface links up with the break provision via an inclining connecting surface, a smoothly proceeding intermediate piece, for instance a surface that proceeds obliquely or in a curved manner, can be created between the top edge of the break provision and the conveying surface. Preferably, the break provision comprises a groove extending in conveying direction with a connecting surface at both sides transversely to the conveying direction.

It is preferred that the module is manufactured from thermoplastic plastic material by means of injection molding as molding technique. Suitable plastic materials are for instance polyester or acetal. The hinge pin is also preferably manufactured from plastic material, for instance polypropylene or polyester.

By providing several break provisions transversely to the conveying direction, for instance at a pitch of approximately 3 inches or of approximately 85 mm, with a limited number of different modules, a large variety in width dimensions of the conveyor mat can be realized. Further, the modules can then for instance be injection molded in a relatively large width, for instance approximately 12 or 24 inches for a system with American dimensions or approximately 170 or 255 mm for a system with European dimensions. As a result, the manufacturing process can be executed in an efficient manner.

The invention also relates to a modular conveyor mat, in particular with modules as described hereinabove, comprising a number of rows of modules successive in conveying direction which are coupled by means of hinge pins extending transversely to the conveying direction, wherein in at least a number of rows of modules, a module with a molded side is adjacent to a module with a broken side, and wherein an end surface of the molded side is partly or completely recessed transversely to the conveying direction, so that a compensation space is created for receiving projections at the broken side. By thus having a broken side cooperate with an at least locally somewhat shorter, molded side, the break parts can be reliably included in the mat without further finishing operations.

The invention will be further elucidated on the basis of a non-limitative exemplary embodiment which is represented in a drawing. In the drawing:

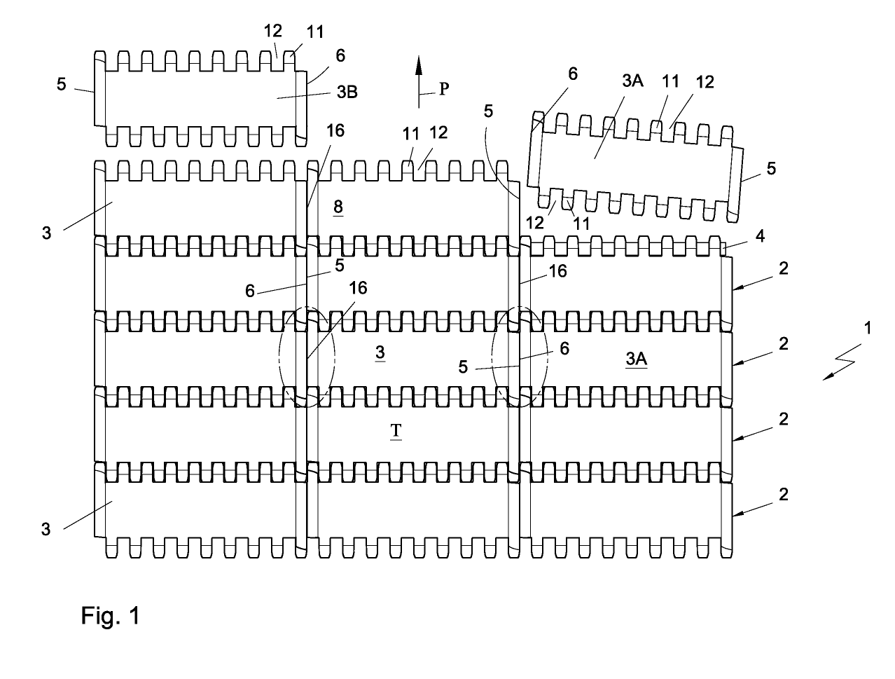

FIG. 1 shows a schematic top plan view of a modular conveyor mat with broken and unbroken modules;

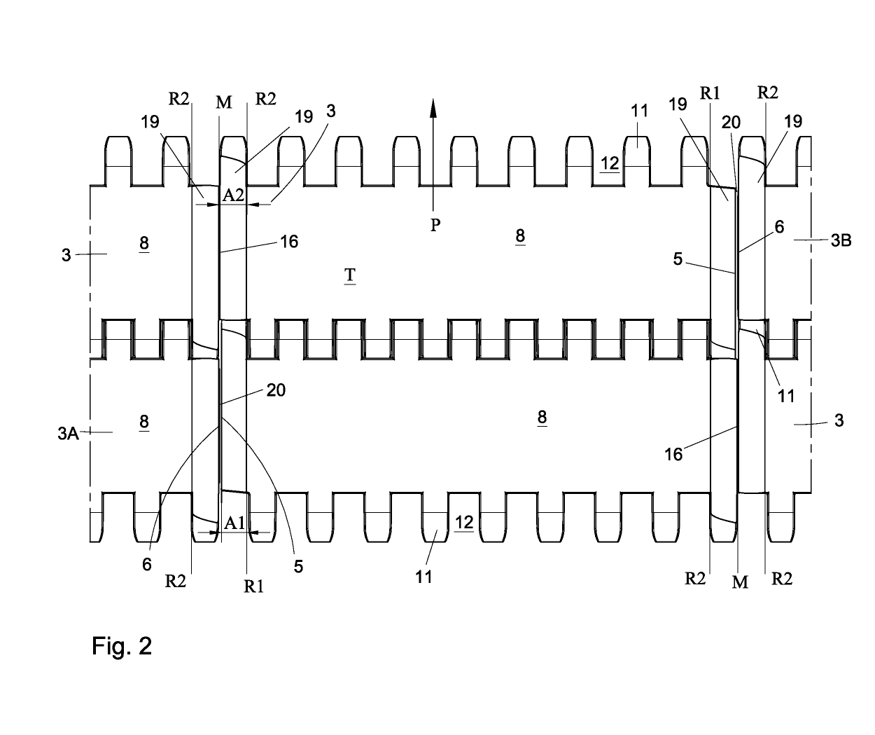

FIG. 2 shows a schematic top plan view of a detail of FIG. 1;

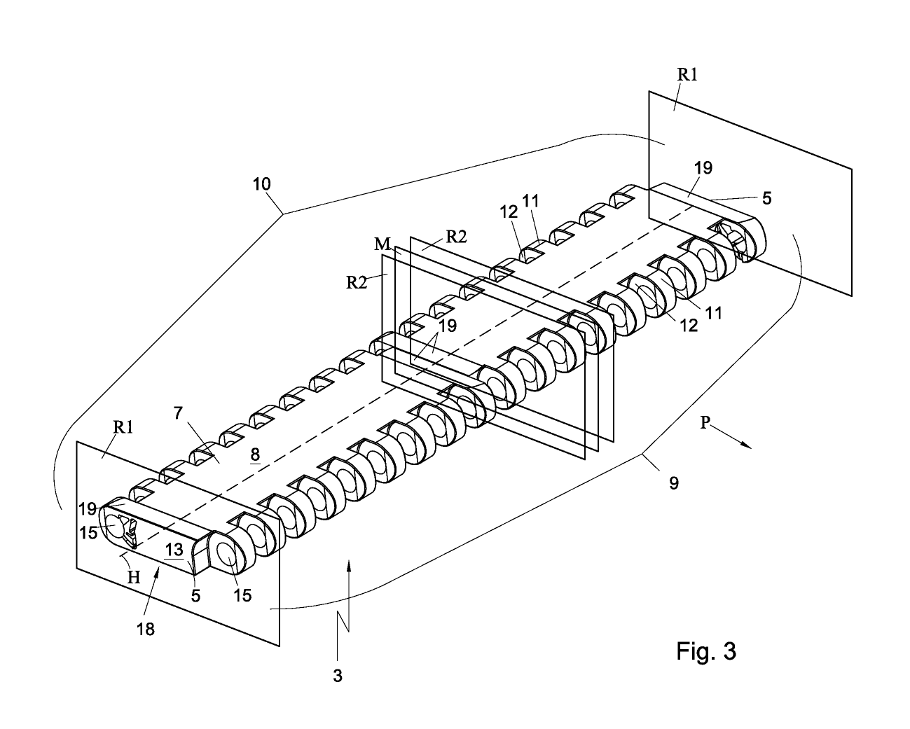

FIG. 3 shows a schematic perspective top plan view of an unbroken module of the mat of FIG. 1;

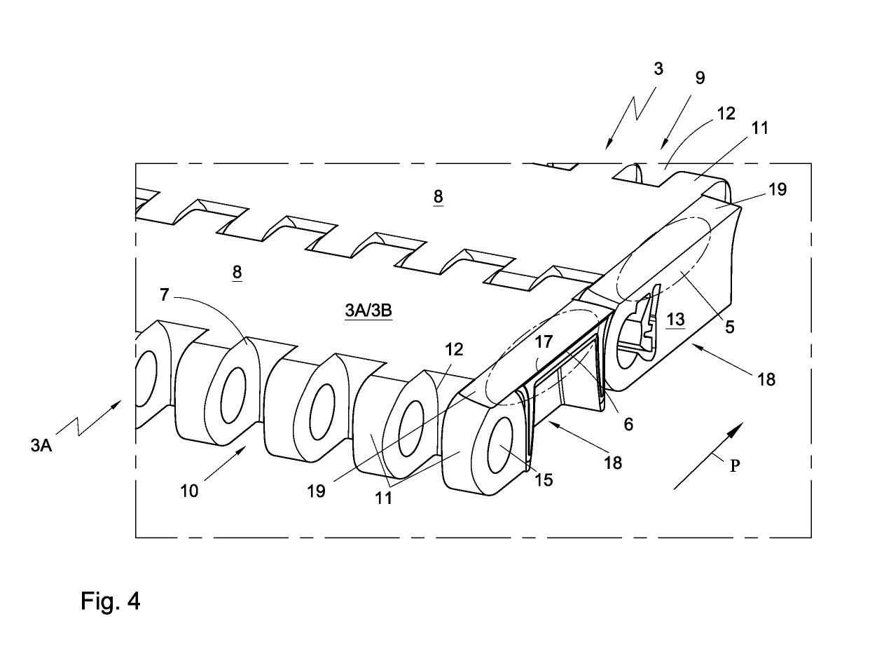

FIG. 4 shows a schematic perspective view of a broken and an unbroken module,

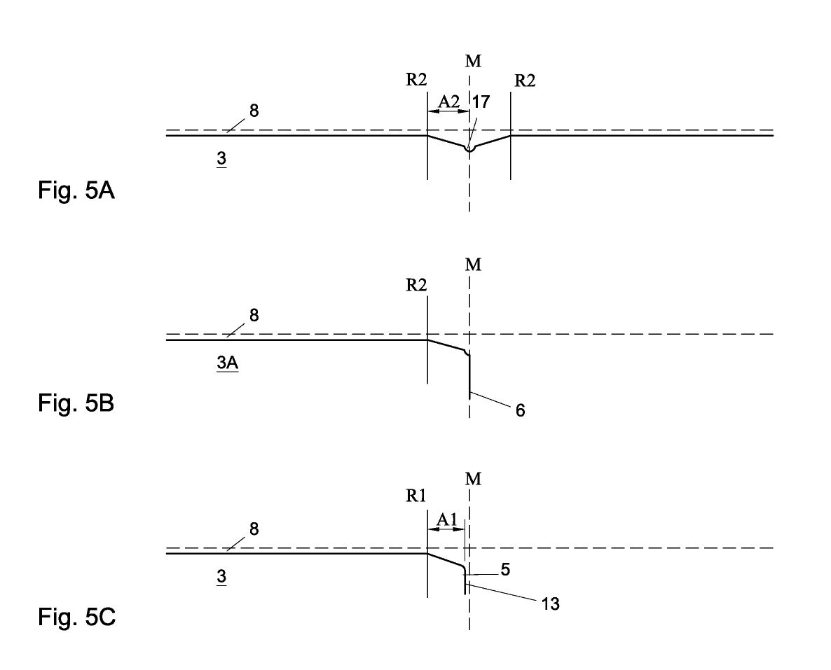

FIG. 5A shows a schematic side view of an unbroken module at the location of the break provision;

FIG. 5B shows a schematic side view of a break part of the module of FIG. 5A, and

FIG. 5V shows a schematic side view of a module at the location of the molded side.

It is noted that the figures are merely schematic representations of a preferred embodiment of the invention. In the Figures, identical or corresponding parts are represented with the same reference numerals.

FIGS. 1 and 2 show a modular conveyor mat 1. The modular conveyor mat 1 comprises a number of rows 2, successive in a conveying direction indicated with arrow P, of modules 3 adjacent transversely to the conveying direction. In FIG. 2, it can be seen that modules 3 successive in conveying direction P are hingedly coupled by means of hinge pins 4 extending transversely to the conveying direction. Here, in each row 2, an unbroken module 3 is placed next to a break part 3a of a broken module, so that a molded side 5 of an unbroken module 3, while forming a compensation space 20 for possible projections, is adjacent a broken side 6 of a broken module 3a/3b. In FIG. 1 it is shown how break parts 3a, 3b of a broken module are included alternately on both sides of the mat 1, so that successive rows of modules 3 are mutually staggered according to a brick pattern. With reference to FIG. 3, it is shown that the modules 3 comprise a body part 7 extending between two molded sides 5 transversely to the conveying direction P along a main axis H, with a top side 8 which forms a substantially flat conveying surface T for conveying products thereon. The body part 7 of the modules 3 further has a front side 9 located in a conveying direction of the module 3 and a rear side 10 located in a conveying direction P of the module. At their front side 9 and rear side 10, the modules 3 are provided with coupling elements 11, 12. The opposite coupling elements 11, 12 at the front side and rear side form a pair. The coupling elements at both the front side 9 and the'rear side 10 form a series of hinge parts 11 and receiving spaces 12 alternately successive transverse to the conveying direction P. In

FIG. 2 it can be clearly seen that hinge parts 11 and adjacent receiving spaces 12 of modules 3 successive in conveying direction P can interdigitate with receiving spaces 11 and hinge parts 12 of adjacent, similar modules 3.

The hinge parts 11 are provided with hinge holes 15 through which reach the hinge pins 4 that extend transversely to the conveying direction. By designing the receiving spaces 12 transversely to the conveying direction P to be a little wider than the hinge parts 11, a loose fit can be created so that the modules 2 can easily interdigitate and smoothly hinge relative to each other. The body part 7 is provided with a break provision 16 extending in conveying direction P, for breaking the module therealong into break parts 3a, 3b. Here, the break provision 16 is located in the body part 7 at the location of the boundary between a hinge part 11 and a receiving space 12.

In FIGS. 2 and 3, in a module 3, a first reference plane R1 is represented which extends, counted from the molded side 5 transversely to the conveying direction P, centrally between the first two pairs of coupling elements 11, 12. Further, in the module 3, a central plane M is represented, which extends centrally through the break provision 16. Further, a second reference plane R2 is represented which extends, counted from the central plane M transversely to the conveying direction P, centrally between the first two pairs of coupling elements 11, 12. The central plane M and the reference planes R1, R2 are oriented transversely to the main axis H of the module 3.

The molded side 5 of the body part 7 of the module 3 comprises an end surface 13 which, during use, can be next to an end surface of an adjacent module. Transversely to the conveying direction P, the end surface 13 has a distance A1 to a first reference plane R1 which is at least locally smaller than the distance A2 from a central plane M through the break provision to a second reference plane R2. This can be clearly seen in FIG. 2 and in FIGS. 5A-5C.

By thus designing the end surface 13 located at the molded side 5 to be receded transversely to the conveying direction, the conveyor mat to be formed with the modules has a compensation space 20. When, as shown in

FIG. 4, upon breaking the module 3, the line of fracture deflects slightly, at least locally, from the central plane M, and due to the rough breaking line, one of the break parts 3a,3b has a projection projecting at the broken side 6 transversely to the conveying direction, this break part can still be included in the conveyor mat 1. Here, as shown in FIG. 1 and FIG. 2, the break part 3a, 3b can be placed with the broken side 6 adjacent a molded side 5 of another module 3 so that the space taken up by the projection can be compensated by means of the compensating space 20 created by the receded end surface.

In this example, the distance between the end surface 20 and the first reference plane R1 is approximately 15% smaller than the distance between the central plane M and the second reference plane R2. When cooperating with a broken module, the width of the compensating space 20 can nominally be, with a hinge part of approximately 4 mm and a receiving opening of approximately 4.2 mm, for instance, approximately 0.2-0.3 mm, with the clearance between the coupling elements and the normal manufacturing tolerance included, this intermediate space can be as great as for instance approximately 0.6 mm.

A top edge 17 of the break provision 16 is located closer to a lower side 18 of the module 3 than to the conveying surface T located at a top side 8 of the module. The top edge 17 of the break provision 16 may be located approximately 0.2 to approximately 1 mm lower than the conveying surface T, with a height of the module of, for instance, approximately 9 mm. Then, the conveying surface T can link up, on both sides via an inclining connecting surface 19, with the break provision 16, and with the molded sides 5. In this exemplary embodiment, the break provision 16 is designed as a groove extending in conveying direction P at the top side 8 of the body part 7, with a substantially obliquely running connecting surface 19 extending at both sides transversely to the conveying direction P.

The invention is not limited to the exemplary embodiment represented here. In particular, instead of as a continuous groove, the break provision can be designed as an interrupted groove or as a different material weakening. Further, if desired, the top edge of the break provision can be located at substantially the same height as the conveying surface.

Depending on the design of the module, further, the configuration of the coupling elements can be varied. In a different configuration, on one of the molded sides, two hinge parts can be located opposite each other, while at the opposite molded side, two receiving spaces are located opposite each other. Also, the pattern of the coupling elements can be irregular, and within the series of coupling elements, the shape and size of the coupling elements can be varied. Also, the break provision can extend over a hinge part, and the body part of the module can for instance have an undulating design as in U.S. Pat. No. 5,215,185. In addition, the conveying surface can not only be designed to be closed as in the exemplary embodiment, but it can also be provided with openings for, for instance, allowing the passage of liquid.

Such variants will be clear to the skilled person and are understood to fall within the reach of the invention as set forth in the following claims.

### REFERENCE NUMERALS

1 modular conveyor mat
2 row of modules
3 module; 3A/3B break parts
4 hinge pin
5 molded side
6 broken side
7 body part
8 top side
9 front side
10 rear side
11 hinge part
12 intermediate space
13 end face
14 x
15 hinge hole
16 break provision
17 top edge
18 lower side
19 inclining surface
20 compensation space
A₁ distance end surface—R₁
A₂ distance M—R₁
P conveying direction
T conveying surface

1. A module for a modular conveyor mat, said module comprising a body part extending between two molded sides transversely to a conveying direction along a main axis, with a top side for carrying products to be conveyed and a lower side for cooperation with a conveying track, said top side and bottom side joined by a front side and a rear side viewed in the conveying direction;
coupling elements provided at the front side and rear side of the body part, wherein opposite coupling elements at the front and rear side form a pair, and wherein the coupling elements at both the front and rear side comprise a series of successive hinge parts and receiving spaces alternating transversely to the conveying direction, so that hinge parts and receiving spaces can interdigitate with receiving spaces and hinge parts of similar modules successive in conveying direction, and the successive modules can be hingedly coupled by means of hinge pins reaching through hinge bores provided in the hinge parts and extending transversely to the conveying direction; and
at least one break provisions extending in the conveying direction for breaking the module therealong in width parts, wherein an end surface of the body part located at a molded side has a first distance, transversely to the conveying direction, to a first reference plane which is at least locally smaller than a second distance from a central plane through the at least one break provision to a second reference plane, wherein, counted from the molded side transversely to the conveying direction, the first reference plane extends between a first two pairs of coupling elements, and wherein, counted from the central plane transversely to the conveying direction, the second reference plane extends centrally between the first two pairs of coupling elements, and wherein the central plane and the reference planes are oriented transversely to the main axis.

2. A module according to claim 1, wherein the at least one break provision is located in the body part at the location of the boundary between a hinge part and an adjacent receiving space.

3. A module according to claim 1, wherein a top edge of the at least one break provision is located at a distance from a conveying surface formed by the top of the module.

4. A module according to claims 1, wherein the top of the body part links up via an inclining connecting surface with the at least one break provision.

5. A module according to claims 1, wherein the top of the body part links up via an inclining connecting surface with a molded side of the body part.

6. A module according to claims 1, wherein the at least one break provision comprises a groove with a connecting surface on both sides.

7. A module according to claims 1, wherein the body part is manufactured from plastic material, material.

8. A module according to claims 1, wherein the body part is formed by injection molding in a mold.

9. A module according to claim 1, wherein transversely to the conveying direction several break provisions are provided, preferably at a pitch of approximately 3 inches to approximately 85 cm.

10. A modular conveyor mat, comprising a number of rows of modules successive in conveying direction which are coupled by hinge pins extending transversely to the conveying direction, at least one of the modules according to claim 1, wherein in at least a number of rows of modules a module with a molded side is adjacent to a module with a broken side, and wherein, transversely to the conveying direction, an end surface of the molded side is partly or completely receded, so that a compensating space is created for receiving projections at the broken side.
